(19) United States
(12) Patent Application Publication
(10) Pub. No.: US 2026/0215415 A1
(43) Pub. Date: Jul. 30, 2026

(54) COMPOSITIONS COMPRISING 4-MEMBERED RING CARBOXAMIDE COMPOUNDS

(71) Applicant: SYNGENTA CROP PROTECTION AG, Basel (CH)

(72) Inventors: Colin Douglas MILN, Greensboro, NC (US); Matthew Robert COTTLE, Greensboro, NC (US); Andrew James COUGHLIN, Greensboro, NC (US)

(73) Assignee: SYNGENTA CROP PROTECTION AG, Basel (CH)

(21) Appl. No.: 19/144,681

(22) PCT Filed: Dec. 19, 2023
(86) PCT No.: PCT/EP2023/086537

§ 371 Date: Jun. 30, 2025

Related U.S. Application Data
(60) Provisional application No. 63/477,940, filed on Dec. 30, 2022.

(51) Int. Cl. A01N 25/04; A01N 25/30; A01N 43/40; A01P 3/00; A01P 5/00

(52) U.S. Cl. CPC A01N 25/04; A01N 25/30; A01N 43/40; A01P 3/00; A01P 5/00; A01N 2300/00

(57) ABSTRACT

The present invention relates to a stable, single-phase emulsifiable or dispersible composition, comprising: (a) one or more compounds selected from N-[(1,2 cis)-2-(2,4- dichlorophenyl)cyclobutyl]-2-(trifluoromethyl)pyridine-3-carboxamide (1, cyclobutrifluram), and the following close analogues thereof: N-[(1,2 cis)-2-(2,4-difluorophenyl)cyclobutyl]-2-(trifluoromethyl)- benzamide (2); N-[(1,2 cis)-2-(2,4-difluorophenyl)cyclobutyl]-2-(trifluoromethyl)pyridine-3- carboxamide (3); N-[(1,2 cis)-2-(2,4-difluorophenyl)cyclobutyl]-3-(trifluoromethyl)pyrazine-2- carboxamide (4); N-[(1,2 cis)-2-[2-chloro-4-(trifluoromethyl)phenyl]cyclobutyl]-3-(trifluoromethyl)pyridine-2-carboxamide (5); N-[(1,2 cis)-2-[2-chloro-4-(trifluoromethyl)-phenyl]cyclobutyl]-2-(trifluoromethyl)pyridine-3-carboxamide (6); N-[(1,2 cis)-2-[2-chloro-4-(trifluoromethyl)phenyl]cyclobutyl]-3-(trifluoromethyl)pyrazine-2-carboxamide (7); N-[(1,2 cis)-2-[2- fluoro-4-(trifluoromethyl)phenyl]cyclobutyl]-2-(trifluoromethyl)benzamide (8); N-[(1,2 cis)-2-[2- fluoro-4-(trifluoromethyl)phenyl]cyclobutyl]-3-(trifluoromethyl)pyridine-2-carboxamide (9); N-[(1,2 cis)-2-[2-fluoro-4-(trifluoromethyl)phenyl]cyclobutyl]-2-(trifluoromethyl)pyridine-3-carboxamide (10); N-[(1,2 cis)-2-[2-fluoro-4-(trifluoromethyl)phenyl]cyclobutyl]-3-(trifluoromethyl)pyrazine-2- carboxamide (11); N-[(2,3 cis)-2-(2,4-difluorophenyl)oxetan-3-yl]-2-(trifluoromethyl)benzamide (12); N-[(2,3 cis)-2-(2,4-difluorophenyl)oxetan-3-yl]-2-(trifluoromethyl)pyri-dine-3-carboxamide (13); N- [(1,2 cis)-2-(2,4-dichlorophenyl)cyclobutyl]-3-(trifluoromethyl)pyridine-2-carboxamide (14); N-[(1,2 cis)-2-(2-chloro-4-fluoro-phenyl)cyclobutyl]-2-(trifluoromethyl)pyridine-3-carboxamide (15); N-[(1,2 cis)-2-(2-chloro-4-fluoro-phenyl)cyclobutyl]-3-(trifluoromethyl)pyridine-2-carboxamide (16); N-[(1,2 cis)-2-(2,4-difluorophenyl)cyclobutyl]-3-(trifluoromethyl) pyridine-2-carboxamide (17); N-[(1,2 cis)-2-(4-chloro-2-fluoro-phenyl)cyclobutyl]-3-(trifluoromethyl)pyridine-2-carboxamide (18); N-[(1,2 cis)-2- (2-ch Io ro-4-fluoro-phenyl)cyclobutyl]-2-(trifluoromethyl) benzamide (19); N-[(1,2 cis)-2-[4-fluoro-2-(trifluoromethyl)phenyl]cyclobutyl]-2-(trifluoromethyl)pyridine-3-carboxamide (20); N-[(1,2 cis)-2-(4-chloro-2-fluoro-phenyl)cyclobutyl]-2-(trifluoromethyl)pyridine-3-carboxamide (21); N-[(1,2 cis)-2-(2-chloro-4-fluoro-phenyl)cyclobutyl]-4-(trifluoromethyl)thiazole-5-carboxamide (22); N-[(1,2 cis)-2-(4-chloro-2-fluoro-phenyl)cyclobutyl]-3-(trifluoromethyl)pyrazine-2-carboxamide (23); N-[(1,2 cis)-2-(4-chloro-2-fluoro-phenyl)cyclobutyl]-2-(trifluoromethyl)benzamide (24); and N-[(1,2 cis)-2-(2,4- difluorophenyl)cyclobutyl]-4-(trifluoromethyl)thiazole-5-carboxamide (25); N-[(1,2 cis)-2-(2,4- dichlorophenyl)cyclobutyl]-2-(trifluoromethyl)pyridine-3-carboxamide (26); N-[(1,2 cis)-2-(2,4-difluorophenyl)cyclobutyl]-2-(trifluoromethyl)benzamide (27); N-[(1,2 cis)-2-(2,4-difluorophenyl)cyclobutyl]-2-(trifluoromethyl)pyridine-3-carboxamide (28); N-[(1,2 cis)-2-(2,4-difluorophenyl)cyclobutyl]-3-(trifluoromethyl)pyrazine-2-carboxamide (29); N-[(2,3 cis)-2-(2,4-difluorophenyl)oxetan-3-yl]-2-(trifluoromethyl)benzamide (30); N-[(2,3 cis)-2-(2,4-difluorophenyl)oxetan-3-yl]-2-(trifluoromethyl)pyridine-3-carboxamide (31); N- [(1,2 cis)-2-(2-chloro-4-fluoro-phenyl)cyclobutyl]-2-(trifluoromethyl)pyridine-3-carboxamide (32); N-[(1,2 cis)-2-(2-chloro-4-fluoro-phenyl)cyclobutyl]-3-(tri-fluoromethyl)pyridine-2-carboxamide (33); N-[(1,2 cis)-2-(2,4-difluorophenyl)cyclobutyl]-3-(trifluoromethyl)pyridine-2-carboxamide (34); N-[(1,2 cis)-2-(4-chloro-2-fluoro-phenyl)cyclobutyl]-3-(trifluoromethyl)pyridine-2-carboxamide (35); and N-[(1,2 cis)-2-(4-chloro-2-fluoro-phenyl) cyclobutyl]-2-(trifluoromethyl)pyridine-3-carboxamide (36), stereoisomers, tautomers, salts or N-oxides thereof; and (b) a solvent system comprising: (i) at least one non-aqueous polar solvent classified by a Hp (Hansen Polarity) value in the range of from 5 to 15 and a Hh (Hansen H-Bonding) parameter in a range of from 5 to 15, and (ii) at least one water immiscible apolar solvent; and (c) an emulsifying surfactant system enabling an oil in water emulsion to be formed when the emulsifiable concentrate is added to water, thereby forming an Emulsifiable concentrate (EC).

### FILED OF THE INVENTION

The invention relates to an emulsifiable concentrate (EC) formulation of compounds comprising 4-membered ring carboxamide, in particular agrochemically active cyclobutylcarboxamide compounds utilising an improved solvent system comprising a primary solvent in combination with one or more co-solvents.

### BACKGROUND OF THE INVENTION

4-membered ring carboxamide compounds have recently found increasing interest as agrochemicals due to their broad-spectrum activity against nematodes and key fungal diseases. In particular Cyclobutylcarboxamide compounds, and close analogues thereof comprising 4-membered rings in the core structures, and processes for their preparation, have been disclosed for instance in WO2013/143811, WO2015/003951, WO2015/022265 and WO2019/158476.

A particularly effective cyclobutylcarboxamide compound, having the ISO name “cyclobutrifluram” is currently pursued as a potent nematicide. The chemical structure of cyclobutrifluram is depicted according to formula (I):

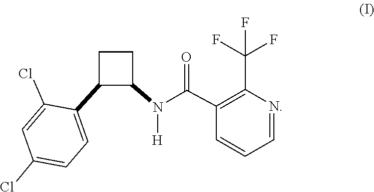 [SMILES: O=C(N[C@@H]1CC[C@@H]1c1ccc(Cl)cc1Cl)c1cccnc1C(F)(F)F]

Some activities of cyclobutrifluram, salts or N-oxides thereof, and close analogues thereof against root-knot nematodes such as Meloidogyne genus and cyst-forming nematodes such as Heterodera genus have been reported, as well as some fungicidal activities.

Most cyclobutylcarboxamide compound formulations proposed today are water-borne, e.g. emulsions or dispersions. While this provides for a very efficient, safe and environmentally friendly way of applying these compositions, there are some features that may limit their industrial applicability. For instance, water-borne formulations comprising cyclobutylcarboxamide compounds may exhibit fast crystallisation tendency, and/or increased crystal size growth, depending on storage and dilution conditions. While this may be useful for certain applications, for the industrial applicability it is often necessary that the active ingredients are provided in a form that can be used directly, or within a few days after dilution in water before the actual application, such as field or greenhouse spraying. Active ingredient emulsions or dispersions should exhibit a sufficiently high phase separation stability not only immediately after dilution with water, but retain this stability for a suitably elongated period to allow for application. Presence of crystals above a certain size may then impact filterability and/or spray applicability, whereby obstruction of pumps, lines and spray nozzles may render an effective and homogeneous application difficult.

Also, where wetting of a target substrate is desired, and eventually, (bio)availability in the field or greenhouses or other locations such as leaves, in furrow, soil surface or underground soil and surface or underground water reservoirs, it may be desirable to show a specific level of crystallisation.

Accordingly, there remains a need to provide a substantially storage-stable and dilution-stable emulsifiable concentrate (EC) formulation. Furthermore, it may be useful to provide such compositions in a form that can be used for dilution in water only before the actual application, such as field or greenhouse spraying. Ideally, such compositions should also be storage stable under a wide range of conditions, without chemically or physically affecting the active ingredient quality, and without inducing crystallizing.

Considering the variety of conditions and special situations under which pesticides are stored, shipped and used around the world, there remains a need for EC premix formulations of pesticides that provide stability benefits under at least some of those conditions and situations.

There is a further need for EC premix formulations which can be readily prepared from commercially available aqueous pesticide components, preferably compositions that are storage stable for at least several weeks, preferably for at least one year, and under temperature conditions ranging from −10° C. to +54° C.

### BRIEF SUMMARY OF THE INVENTION

Hence, in a first aspect of the present invention provides a stable, single-phase emulsifiable or dispersible composition, comprising: (a) one or more compounds selected from: N-[(1,2 cis)-2-(2,4-dichlorophenyl)cyclobutyl]-2-(trifluoromethyl)pyridine-3-carboxamide (1, cyclobutrifluram), and the following close analogues thereof: N-[(1,2 cis)-2-(2,4-difluorophenyl)cyclobutyl]-2-(trifluoromethyl)benzamide (2); N-[(1,2 cis)-2-(2,4-difluorophenyl)cyclobutyl]-2-(trifluoromethyl)pyridine-3-carboxamide (3); N-[(1,2 cis)-2-(2,4-difluorophenyl)cyclobutyl]-3-(trifluoromethyl)pyrazine-2-carboxamide (4); N-[(1,2 cis)-2-[2-chloro-4-(trifluoromethyl)phenyl]cyclobutyl]-3-(trifluoromethyl)pyridine-2-carboxamide (5); N-[(1,2 cis)-2-[2-chloro-4-(trifluoromethyl)phenyl]cyclobutyl]-2-(trifluoromethyl)pyridine-3-carboxamide (6); N-[(1,2 cis)-2-[2-chloro-4-(trifluoromethyl)phenyl]cyclobutyl]-3-(trifluoromethyl)pyrazine-2-carboxamide (7); N-[(1,2 cis)-2-[2-fluoro-4-(trifluoromethyl)phenyl]cyclobutyl]-2-(trifluoromethyl)benzamide (8); N-[(1,2 cis)-2-[2-fluoro-4-(trifluoromethyl)phenyl]cyclobutyl]-3-(trifluoromethyl)pyridine-2-carboxamide (9); N-[(1,2 cis)-2-[2-fluoro-4-(trifluoromethyl)phenyl]cyclobutyl]-2-(trifluoromethyl)-pyridine-3-carboxamide (10); N-[(1,2 cis)-2-[2-fluoro-4-(trifluoromethyl)phenyl]cyclobutyl]-3-(trifluoromethyl)pyrazine-2-carboxamide (11); N-[(2,3 cis)-2-(2,4-difluorophenyl)oxetan-3-yl]-2-(trifluoromethyl)benzamide (12); N-[(2,3 cis)-2-(2,4-difluorophenyl)oxetan-3-yl]-2-(trifluoromethyl)-pyridine-3-carboxamide (13); N-[(1,2 cis)-2-(2,4-dichlorophenyl)cyclobutyl]-3-(trifluoromethyl)-pyridine-2-carboxamide (14); N-[(1,2 cis)-2-(2-chloro-4-fluoro-phenyl)cyclobutyl]-2-(trifluoromethyl)-pyridine-3-carboxamide (15); N-[(1,2 cis)-2-(2-chloro-4-fluoro-phenyl)cyclobutyl]-3-(trifluoromethyl)-pyridine-2-carboxamide (16); N-[(1,2 cis)-2-(2,4-difluorophenyl)cyclobutyl]-3-(trifluoromethyl)-pyridine-2-carboxamide (17); N-[(1,2 cis)-2-(4-chloro-2-fluoro-phenyl)cyclobutyl]-3-(trifluoromethyl)-pyridine-2-carboxamide (18); N-[(1,2 cis)-2-(2-chloro-4-fluoro-phenyl)cyclobutyl]-2-(trifluoromethyl)-benzamide (19); N-[(1,2 cis)-2-[4-fluoro-2-(trifluoromethyl)phenyl]cyclobutyl]-2-(trifluoromethyl)-pyridine-3-carboxamide (20); N-[(1,2 cis)-2-(4-chloro-2-fluoro-phenyl)cyclobutyl]-2-(trifluoromethyl)-pyridine-3-carboxamide (21); N-[(1,2 cis)-2-(2-chloro-4-fluoro-phenyl)cyclobutyl]-4-(trifluoromethyl)-thiazole-5-carboxamide (22); N-[(1,2 cis)-2-(4-chloro-2-fluoro-phenyl)cyclobutyl]-3-(trifluoromethyl)-pyrazine-2-carboxamide (23); N-[(1,2 cis)-2-(4-chloro-2-fluoro-phenyl)cyclobutyl]-2-(trifluoromethyl)-benzamide (24); and N-[(1,2 cis)-2-(2,4-difluorophenyl)cyclobutyl]-4-(trifluoromethyl)thiazole-5-carboxamide (25); N-[(1,2 cis)-2-(2,4-dichlorophenyl)cyclobutyl]-2-(trifluoromethyl)pyridine-3-carboxamide (26); N-[(1,2 cis)-2-(2,4-difluorophenyl)cyclobutyl]-2-(trifluoromethyl)benzamide (27); N-[(1,2 cis)-2-(2,4-difluorophenyl)cyclobutyl]-2-(trifluoromethyl)pyridine-3-carboxamide (28); N-[(1,2 cis)-2-(2,4-difluorophenyl)cyclobutyl]-3-(trifluoromethyl)pyrazine-2-carboxamide (29); N-[(2,3 cis)-2-(2,4-difluorophenyl)oxetan-3-yl]-2-(trifluoromethyl)benzamide (30); N-[(2,3 cis)-2-(2,4-difluorophenyl)oxetan-3-yl]-2-(trifluoromethyl)pyridine-3-carboxamide (31); N-[(1,2 cis)-2-(2-chloro-4-fluoro-phenyl)cyclobutyl]-2-(trifluoromethyl)pyridine-3-carboxamide (32); N-[(1,2 cis)-2-(2-chloro-4-fluoro-phenyl)cyclobutyl]-3-(trifluoromethyl)pyridine-2-carboxamide (33); N-[(1,2 cis)-2-(2,4-difluorophenyl)cyclobutyl]-3-(trifluoromethyl)pyridine-2-carboxamide (34);
N-[(1,2 cis)-2-(4-chloro-2-fluoro-phenyl)cyclobutyl]-3-(trifluoromethyl)pyridine-2-carboxamide (35); and N-[(1,2 cis)-2-(4-chloro-2-fluoro-phenyl)cyclobutyl]-2-(trifluoromethyl)pyridine-3-carboxamide (36), stereoisomers, tautomers, salts or N-oxides thereof; and (b) a solvent system comprising:
(i) at least one non-aqueous polar solvent classified by a Hp (Hansen Polarity) value in the range of from 5 to 15 and a Hh (Hansen H-Bonding) parameter in a range of from 5 to 15, and
(ii) at least one water immiscible apolar solvent; and
   (c) an emulsifying surfactant system enabling an oil in water emulsion to be formed when the emulsifiable concentrate is added to water, thereby forming an Emulsifiable concentrate (EC).

In a further aspect of the invention, a process is provided for the preparation of a composition according to the invention comprising contacting an aliquot of one or more of compounds 1 to 25 with at least one of the solvents (i) and/or (ii), and optionally, at least a portion of the emulsifying surfactant system, to form the composition as a preformed concentrate composition capable of forming emulsion/micro-emulsion upon dilution with water,

In yet a further aspect of the present invention provides a process for the preparation of an aqueous emulsion or dispersion, comprising contacting a composition according to the invention with an aqueous liquid carrier under conditions inducive of the formation of an emulsion or dispersion.

In a further aspect of the invention, an emulsion-in-water formulation obtainable according to process is provided, comprising a composition of the active ingredient diluted in water, in the form of a concentrated aqueous agrochemical formulation.

In yet a further aspect of the present invention provides a method for preventing or controlling pathogens in crops of useful plants, comprising treating the plants, plant parts, plant propagation materials or locus thereof with an agrochemically effective amount of a water-diluted spray composition or oil-in-water emulsion formed when the composition according to the invention are added to an aqueous liquid carrier.

In yet a further aspect of the present invention provides the use of the composition for the storage and transport of the one or more compounds 1 to 36.

In yet a further aspect of the present invention provides the use of the composition for the preparation of an oil-in-water emulsion.

In yet a further aspect of the present invention provides the use of the composition for the control of undesired plant pathogens, in particular nematodes and/or fungi. Also a method for the control of an undesired plant pathogens, in particular nematodes and/or fungi, comprising dispersing in an aqueous solution the formulation of the invention, and contacting the resulting mixture with the plant, plant propagation material, or the locus of said plant is provided.

### DETAILED DESCRIPTION OF THE INVENTION

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

A “stereoisomer” herein refers to compounds made up of the same atoms bonded by the same sequence of bonds but having different three-dimensional structures which are not interchangeable.

The term “about” as used herein specifically includes ±10% from the indicated values in the range. In addition, the endpoints of all ranges directed to the same component or property herein are inclusive of the endpoints, are independently combinable, and include all intermediate points and ranges.

It is understood that where a parameter range is provided, all integers within that range, and tenths thereof, are also provided by the invention as if the integers and tenths thereof are expressly described herein. For example, “between 75 and 99 w/w %” includes 70.0 w/w %, 70.1 w/w %, 70.2 w/w %, 70.3 w/w %, etc. up to 99.0 w/w %.

“Active Ingredient” herein refers primarily to cyclobutylcarboxamide compounds according to the invention; and secondarily to any additional pesticide, including but not limited to herbicides, insecticides, fungicides, nematicides, acaricides, biocides, and so on. Nonlimiting examples of suitable active pesticides are set forth hereinafter. Table 1 lists compounds 1 to 36 which exhibit selected nematicidal and fungicidal effects.

TABLE 1
Compounds (a)

| Cpd | |
|---|---|
| No. | IUPAC name |
| 1 | N-[(1,2 cis)-2-(2,4-dichlorophenyl)cyclobutyl]-2-(trifluoromethyl)pyridine-3-carboxamide; |
| 2 | N-[(1,2 cis)-2-(2,4-difluorophenyl)cyclobutyl]-2-(trifluoromethyl)benzamide; |
| 3 | N-[(1,2 cis)-2-(2,4-difluorophenyl)cyclobutyl]-2-(trifluoromethyl)pyridine-3-carboxamide; |
| 4 | N-[(1,2 cis)-2-(2,4-difluorophenyl)cyclobutyl]-3-(trifluoromethyl)pyrazine-2-carboxamide; |
| 5 | N-[(1,2 cis)-2-[2-chloro-4-(trifluoromethyl)phenyl]cyclobutyl]-3-(trifluoromethyl)pyridine-2- |
| | carboxamide; |
| 6 | N-[(1,2 cis)-2-[2-chloro-4-(trifluoromethyl)phenyl]cyclobutyl]-2-(trifluoromethyl)pyridine-3- |
| | carboxamide; |
| 7 | N-[(1,2 cis)-2-[2-chloro-4-(trifluoromethyl)phenyl]cyclobutyl]-3-(trifluoromethyl)pyrazine-2- |
| | carboxamide; |
| 8 | N-[(1,2 cis)-2-[2-fluoro-4-(trifluoromethyl)phenyl]cyclobutyl]-2-(trifluoromethyl)benzamide; |
| 9 | N-[(1,2 cis)-2-[2-fluoro-4-(trifluoromethyl)phenyl]cyclobutyl]-3-(trifluoromethyl)pyridine-2- |
| | carboxamide; |
| 10 | N-[(1,2 cis)-2-[2-fluoro-4-(trifluoromethyl)phenyl]cyclobutyl]-2-(trifluoromethyl)pyridine-3- |
| | carboxamide; |
| 11 | N-[(1,2 cis)-2-[2-fluoro-4-(trifluoromethyl)phenyl]cyclobutyl]-3-(trifluoromethyl)pyrazine-2- |
| | carboxamide; |
| 12 | N-[(2,3 cis)-2-(2,4-difluorophenyl)oxetan-3-yl]-2-(trifluoromethyl)benzamide; |
| 13 | N-[(2,3 cis)-2-(2,4-difluorophenyl)oxetan-3-yl]-2-(trifluoromethyl)pyridine-3-carboxamide; |
| 14 | N-[(1,2 cis)-2-(2,4-dichlorophenyl)cyclobutyl]-3-(trifluoromethyl)pyridine-2-carboxamide; |
| 15 | N-[(1,2 cis)-2-(2-chloro-4-fluoro-phenyl)cyclobutyl]-2-(trifluoromethyl)pyridine-3- |
| | carboxamide; |
| 16 | N-[(1,2 cis)-2-(2-chloro-4-fluoro-phenyl)cyclobutyl]-3-(trifluoromethyl)pyridine-2- |
| | carboxamide; |
| 17 | N-[(1,2 cis)-2-(2,4-difluorophenyl)cyclobutyl]-3-(trifluoromethyl)pyridine-2-carboxamide; |
| 18 | N-[(1,2 cis)-2-(4-chloro-2-fluoro-phenyl)cyclobutyl]-3-(trifluoromethyl)pyridine-2- |
| | carboxamide; |
| 19 | N-[(1,2 cis)-2-(2-chloro-4-fluoro-phenyl)cyclobutyl]-2-(trifluoromethyl)benzamide, |
| 20 | N-[(1,2 cis)-2-[4-fluoro-2-(trifluoromethyl)phenyl]cyclobutyl]-2-(trifluoromethyl)pyridine-3- |
| | carboxamide; |
| 21 | N-[(1,2 cis)-2-(4-chloro-2-fluoro-phenyl)cyclobutyl]-2-(trifluoromethyl)pyridine-3- |
| | carboxamide; |
| 22 | N-[(1,2 cis)-2-(2-chloro-4-fluoro-phenyl)cyclobutyl]-4-(trifluoromethyl)thiazole-5- |
| | carboxamide; |
| 23 | N-[(1,2 cis)-2-(4-chloro-2-fluoro-phenyl)cyclobutyl]-3-(trifluoromethyl)pyrazine-2- |
| | carboxamide; |
| 24 | N-[(1,2 cis)-2-(4-chloro-2-fluoro-phenyl)cyclobutyl]-2-(trifluoromethyl)benzamide; and |
| 25 | N-[(1,2 cis)-2-(2,4-difluorophenyl)cyclobutyl]-4-(trifluoromethyl)thiazole-5-carboxamide; |
| 26 | N-[(1,2 cis)-2-(2,4-dichlorophenyl)cyclobutyl]-2-(trifluoromethyl)pyridine-3-carboxamide; |
| 27 | N-[(1,2 cis)-2-(2,4-difluorophenyl)cyclobutyl]-2-(trifluoromethyl)benzamide; |
| 28 | N-[(1,2 cis)-2-(2,4-difluorophenyl)cyclobutyl]-2-(trifluoromethyl)pyridine-3-carboxamide; |
| 29 | N-[(1,2 cis)-2-(2,4-difluorophenyl)cyclobutyl]-3-(trifluoromethyl)pyrazine-2-carboxamide; |
| 30 | N-[(2,3 cis)-2-(2,4-difluorophenyl)oxetan-3-yl]-2-(trifluoromethyl)benzamide; |
| 31 | N-[(2,3 cis)-2-(2,4-difluorophenyl)oxetan-3-yl]-2-(trifluoromethyl)pyridine-3-carboxamide; |
| 32 | N-[(1,2 cis)-2-(2-chloro-4-fluoro-phenyl)cyclobutyl]-2-(trifluoromethyl)pyridine-3- |
| | carboxamide; |
| 33 | N-[(1,2 cis)-2-(2-chloro-4-fluoro-phenyl)cyclobutyl]-3-(trifluoromethyl)pyridine-2- |
| | carboxamide; |
| 34 | N-[(1,2 cis)-2-(2,4-difluorophenyl)cyclobutyl]-3-(trifluoromethyl)pyridine-2-carboxamide; |
| 35 | N-[(1,2 cis)-2-(4-chloro-2-fluoro-phenyl)cyclobutyl]-3-(trifluoromethyl)pyridine-2- |
| | carboxamide; and |
| 36 | N-[(1,2 cis)-2-(4-chloro-2-fluoro-phenyl)cyclobutyl]-2-(trifluoromethyl)pyridine-3- |
| | carboxamide. |

The preparation of compounds of Table 1 including cyclobutrifluram has been described in any of WO2013/143811, WO2015/003951, WO2015/022265 and WO2019/158476, all in the name of SYNGENTA PARTICIPATIONS AG, all of which are incorporated herein by reference.

Preferably, compound (a) comprises one or more stereoisomers of N-[(1,2 cis)-2-(2,4-dichlorophenyl)cyclobutyl]-2-(trifluoromethyl)pyridine-3-carboxamide (Cyclobutrifluram).

Cyclobutrifluram as disclosed above represents the cis racemate: the phenyl ring on the left-hand side and the pyridyl-C(═O)—NH group on the right-hand side are cis to each other on the cyclobutyl ring as illustrated for compound of formula (Ia) and (Ib):

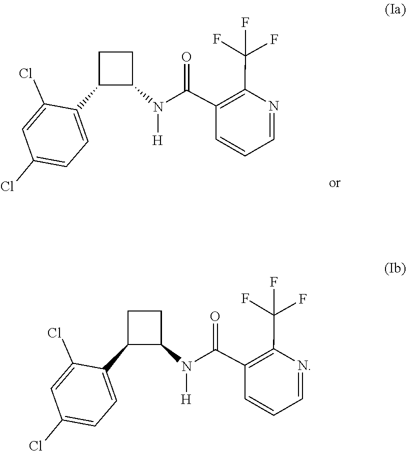 [SMILES: O=C(N[C@H]1CC[C@H]1c1ccc(Cl)cc1Cl)c1cccnc1C(F)(F)F ; O=C(N[C@@H]1CC[C@@H]1c1ccc(Cl)cc1Cl)c1cccnc1C(F)(F)F]

The racemic compound of cyclobutrifluram is a 1:1 mixture of the compounds of formula (Ia) and (Ib). The wedged bonds shown in the compounds of formula (Ia) and (Ib) represent absolute stereochemistry, whereas the thick straight bonds such as those shown for compound of formula (I) represent relative stereochemistry in racemic compounds. It has also surprisingly been found that one enantiomer of cyclobutrifluram is particularly useful in a method for controlling or preventing infestation of plants by a phytopathogenic microorganism of the genus Aspergillus.

Thus, preferably, there is provided the method according to the invention wherein cyclobutrifluram is in the form of the (1S, 2S) stereoisomer (Ia):

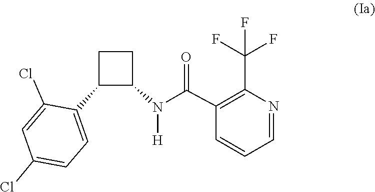 [SMILES: O=C(N[C@H]1CC[C@H]1c1ccc(Cl)cc1Cl)c1cccnc1C(F)(F)F]

A skilled person is aware that according to the method of the invention, cyclobutrifluram is generally applied as part of a pesticidal composition, whereby it is known that the compounds of formula (I) are especially useful for the control of nematodes. Hence there is provided a method for controlling or preventing infestation of plants by a nematode plant pest comprising applying to a crop of plants, the locus thereof, or propagation material thereof a pesticidal composition comprising cyclobutrifluram and one or more formulation adjuvants. In a method according to the invention, for beneficial compositions comprising both the (1S,2S) and (1R,2R) stereoisomers of cyclobutrifluram, the ratio of the (1S,2S) stereoisomer to its enantiomer (1R,2R) is preferably greater than 1:1. More preferably, the ratio of the (1S,2S) to (1S,2S) is greater than 1.5:1, more preferably greater than 2.5:1, especially greater than 4:1, advantageously greater than 9:1, desirably greater than 20:1, in particular greater than 35:1.

Mixtures containing up to 50%, preferably up to 40%, more preferably up to 30%, especially up to 20%, advantageously up to 10%, desirably up to 5%, in particular up to 3%, of the trans stereoisomers of the compounds of formula (I) (i.e. wherein the phenyl and the pyridyl-C(═O)—NH groups are trans to each other) are also understood to be part of this invention. Preferably, the ratio of the cis isomer to its trans isomer is greater than 1.5:1, more preferably greater than 2.5:1, especially greater than 4:1, advantageously greater than 9:1, desirably greater than 20:1, in particular greater than 35:1.

Preferably, the one or more compounds (a) are present in the composition in an amount of from 0.01 to 15% by weight.

Preferably, the composition comprises an amount of water at or below 2% by weight of the composition.

### “Emulsifiable Concentrates”

The present invention relates to pesticidal emulsifiable concentrates, to the preparation thereof and to a method of using such compositions to control pests in crops of useful plants. Emulsifiable concentrate (EC) formulations are favoured liquid delivery systems for agriculturally active compounds. As a rule, conventional ECs contain at least one active ingredient, one or more surfactants which act as emulsifiers upon dilution of the EC with water, and a water immiscible solvent having a low solubility in water and that is capable of dissolving a wide range of active ingredients. Typical ECs contain little, or no water as higher levels of water can cause phase inversion and cream separation. Emulsifiable concentrates may be formulated into water-based emulsions, “EW”, concentrated suspensions “SC”, and other types of formulations for use in agriculture and control of parasites of all taxonomy.

Due to the presence of the solvent, many pesticides formulated as an EC have advantages such as a higher degree of systemicity and higher overall activity compared to the same pesticide formulated as a water dispersible granule (WG) or as oil in water emulsion (EW).

In some cases it may be desirable to combine different pesticides to provide a single formulation taking advantage of the additive properties of each separate pesticide in order to optimize biological performance. Also, transportation and storage costs can be minimized by preparing an EC in which the concentration of the pesticides is as high as is practicable and in which any desired adjuvants are “built-in” to the formulation as opposed to the separate pesticide products and adjuvants being tank-mixed by an end user. However, when pesticide products are combined that have significantly different physical, chemical or biological properties, such as where one pesticide is a water insoluble solid and the other pesticide is a water soluble salt, available, for instance, as an aqueous SL-formulation, the greater is the probability that the stability of an EC premix formulation prepared there from may be disturbed, or that one or more components may separate out from the EC. This is particularly true when there are substantial amounts of water present in the commercially available forms of an individual pesticide component that is used to make an EC premix.

The present formulations are characterised by long half-life (‘shelf stability’), long crystallisation time once the formulation is dissolved in water, improved wettability and excellent emulsion stability.

### “Solvent System”:

### Hansen Solubility Parameters

It has been surprisingly found that a combination of solvents within a specific area of Hansen Solubility Parameters can be used as solvents for emulsifiable concentrate compositions according to the invention, allowing for the formulation of safe aqueous emulsions or dispersions, while retaining active ingredient availability. The present invention thus makes use of a combination of solvents.

The Hansen Solubility Parameters involve a mathematical method of characterizing the power of solvents to dissolve compounds. Hansen Solubility Parameters differ from other solubility parameters in that the Hansen parameter separately calculates the non-polar, polar, and hydrogen bonding components of the total solubility parameter, thereby allowing the formulator to select a solvent based on four parameters rather than just one. The components of the Hansen Solubility Parameter of a solvent are (1) a non-polar index, (2) a polar index, and (3) a hydrogen bonding index. The solubility parameters referred to herein are those disclosed in: “Hansen solubility parameters: a user's handbook.—2nd ed./edited by Charles Hansen, 2000, ISBN 0-8493-7248-8.

It is known empirically that the hydrogen bonding index is an approximate measure of the water solubility of a solvent and can be used to predict which solvents can form stable emulsions. Without wishing to be bound by any particular theory, it is assumed that when solvents are combined into a mixture, the Hansen Solubility Parameters of the mixture are approximately equal to the weighted average of the Hansen Solubility Parameters of the individual solvents, based on the molar volume of each solvent.

### Useful Solvents

In general, a solvent or solvent blend having a high polar index, of greater than 5.0 and up to and including 15.0, and having a high hydrogen bonding index, of greater than 5.0 and up to and including 15.0, were found as effective solvents for compositions according to the present invention.

Preferably, the solvents of the composition of the present invention have flash points above 50° C., more preferably above 90° C., because these solvents are generally safer to use, and act as latent solvent in emulsions or dispersions, thereby reducing the tendency to crystallize of the active ingredient in the organic phase. The active ingredient of the composition should be soluble in the solvent composition. The solvent system comprises two components, (i) and (ii).

Any suitable solvent or solvent mixture as component (i) can be used that meets the required Hansen parameters, optionally with addition of one or more ionic or non-ionic surfactants or emulsifiers. The solvent component (i) preferably also meet the requirements of the application as an agrochemical composition. Suitable solvents display many or all of the following properties: an excellent dissolving power for pesticides or other organic molecules; made from plant or animal renewable resources; low skin irritation; low ecotoxicity, for example to daphnia; low volatile organic content; and a high flash point. The compositions of the present invention each display all or many of these properties, in particular an excellent dissolving power, the compounds may be used effectively as solvents. Table 2 shows the Hansen Parameters of a number of useful solvents:

TABLE 2
Hansen Parameters of useful solvents

| Solvents | dD | dP | dH |
|---|---|---|---|
| Acetone | 15.5 | 10.4 | 7 |
| n-Amyl Alcohol | 15.9 | 5.9 | 13.9 |
| Benzyl Alcohol | 18.4 | 6.3 | 13.7 |
| Benzyl Benzoate | 20 | 5.1 | 5.2 |
| 2-Butanol | 15.8 | 5.7 | 14.5 |
| t-Butyl Alcohol | 15.2 | 5.1 | 14.7 |
| Butyl Benzoate | 18.3 | 5.6 | 5.5 |
| Butyl Glycol Acetate | 15.3 | 7.5 | 6.8 |
| n-Butyl Propionate | 15.7 | 5.5 | 5.9 |
| Caprolactone (Epsilon) | 19.7 | 15 | 7.4 |
| m-Cresol | 18.5 | 6.5 | 13.7 |
| Cyclohexanone | 17.8 | 8.4 | 5.1 |
| Diacetone Alcohol | 15.8 | 8.2 | 10.8 |
| Dimethyl Sulfoxide (DMSO) | 18.4 | 16.4 | 10.2 |
| 1,3-Dioxolane | 18.1 | 6.6 | 9.3 |
| Dipropylene Glycol Methyl Ether | 15.5 | 5.7 | 11.2 |
| Dipropylene Glycol Mono n-Butyl Ether | 15.7 | 6.5 | 10 |
| Ethyl Acetate | 15.8 | 5.3 | 7.2 |
| Ethyl Lactate | 16 | 7.6 | 12.5 |
| Ethylene Glycol | 17 | 11 | 26 |
| Ethylene Glycol Monobutyl Ether | 16 | 5.1 | 12.3 |
| Ethylene Glycol Monomethyl Ether | 16 | 8.2 | 15 |
| iso-Pentyl Alcohol | 15.8 | 5.2 | 13.3 |
| Isophorone | 17 | 8 | 5 |
| Methyl Acetate | 15.5 | 7.2 | 7.6 |
| Methyl Carbitol | 16.2 | 7.8 | 12.6 |
| Methyl Cellosolve | 16 | 8.2 | 15 |
| Methyl Ethyl Ketone (MEK) | 16 | 9 | 5.1 |
| N-Methyl-2-Pyrrolidone (NMP) | 18 | 12.3 | 7.2 |
| Methylene Chloride | 17 | 7.3 | 7.1 |
| N,N-Dimethyl Acetamide | 16.8 | 11.5 | 10.2 |
| N,N-Dimethyl Formamide (DMF) | 17.4 | 13.7 | 11.3 |
| 1-Nitropropane | 16.6 | 12.3 | 5.5 |
| 2-Phenoxy Ethanol | 17.8 | 5.7 | 14.3 |
| n-Propyl Propanoate | 15.5 | 5.6 | 5.7 |
| Propylene Glycol Monoethyl Ether | 15.6 | 6.3 | 7.7 |
| Acetate | | | |
| Propylene Glycol Monomethyl Ether | 15.6 | 6.3 | 11.6 |
| Propylene Glycol Monomethyl Ether | 15.6 | 5.6 | 9.8 |
| Acetate | | | |
| Propylene Glycol Phenyl Ether | 17.4 | 5.3 | 11.5 |
| Sulfolane (Tetramethylene Sulfone) | 18 | 18 | 9.9 |
| Tetrahydrofuran (THF) | 16.8 | 5.7 | 8 |
| Tetrahydrofurfuryl Alcohol | 17.8 | 8.2 | 12.9 |

Accordingly, useful solvents (i) that have the required Hp and Hh values (i.e. the dP and dH values in the table herein above) include Acetone, n-Amyl Alcohol, Benzyl Alcohol, Benzyl Benzoate, 2-Butanol, t-Butyl Alcohol, Butyl benzoate, Butyl Glycol Acetate, n-Butyl Propionate, ε-Caprolactone, m-Cresol, Cyclohexanone, Diacetone Alcohol, Dimethyl Sulfoxide (DMSO), 1,3-Dioxolane, Dipropylene Glycol, Methyl Ether, Dipropylene Glycol Mono n-Butyl Ether, Ethyl Acetate, Ethyl Lactate, Ethylene Glycol, Ethylene Glycol Monobutyl Ether, Ethylene Glycol Monomethyl Ether, iso-Pentyl Alcohol, Isophorone Methyl Acetate, Methyl Carbitol, Methyl Cellosolve, Methyl Ethyl Ketone (MEK), N-Methyl-2-Pyrrolidone (NMP), Methylene Chloride, N,N-Dimethyl Acetamide, N,N-Dimethyl Formamide (DMF), 1-Nitropropane, 2-Phenoxy Ethanol, n-Propyl Propanoate, Propylene Glycol Monoethyl Ether Acetate, Propylene Glycol Monomethyl Ether, Propylene Glycol Monomethyl Ether Acetate, Propylene Glycol Phenyl Ether, Sulfolane (Tetramethylene Sulfone), Tetrahydrofuran (THF) and/Tetrahydrofurfuryl Alcohol.

Other examples of suitable non-aqueous, polar solvents (i) include acetone, amyl acetate, butanol, benzyl alcohol, cetyl alcohol, dimethyl ether, dipropylene glycol, diethylene glycol monomethyl ether, octanol, hallcomid M-8-10, hexylene glycol, cyclohexanol, ethyl lactate, ethyl alcohol, 2-ethyl hexanol, glycerol monoacetate, glycerol diacetate, glycerol triacetate, 3-hexenol, n-hexyl alcohol, isopropyl myristate, lactic acid, lactic acid 2-ethyl hexyl ester, lactic acid n-propyl ester, methyl alcohol, methyl n-amyl ketone, methyl isobutyl ketone, oleyl alcohol, propanol, tetrahydrofurfuryl alcohol, butyrolactone, chlorobenzene, diacetone alcohol, n-decanol, N,N-dimethyl decanamide, N,N-dimethyl octanamide, dimethyl lactamide, n-decyl alcohol, dipropyleneglycol monomethylether, ethylene glycol monobutyl ether, isobutyl alcohol, mesityl oxide, methyl ethyl ketone, 2-methyl-2,4-pentanediol, N-octyl pyrrolidone, N-methyl pyrrolidone, n-octyl alcohol, oxo-decyl acetate, oxo-heptyl acetate, oxo-hexyl acetate, oxo-nonyl acetate, oxo-octyl acetate, oxo-tridecyl acetate, propyleneglycol monomethyl ether, triethylene glycol, triethyl phosphate, lactic acid n-butyl ester, lactic acid ethyl ester, dodecyl pyrrolidone, N,N-dimethyl acetamide, propylene carbonate and mixtures thereof.

Preferred solvents are non-hydroxyl-group-containing solvents, especially those such as γ-caprolactone, also referred to as γ-hexylactone; ethyl butyrolactone; γ-ethyl-n-butyrolactone; hexanolide-1,4; 4-hydroxy hexanoic acid γ-lactone or tonkalide), 6-hexylactone, γ-butyrolactone etc. γ-Hexylactone, Synperonic NCA 830, and dimethyl sulfoxide are employed within some embodiments of the present invention.

Within other embodiments, solvents such as N,N-diethyl-m-toluamide, eucalyptol, dimethyl isosorbide, diisopropyl adipate and/or 1-methoxy-2-propyl acetate may be advantageously utilized in combination with the γ-hexylactone to comprise the carrier solvent component (i).

Particularly preferred are N-methyl-2-pyrrolidone (NMP), γ-caprolactone, N-butylpyrrolidone, tetrahydrofurfuryl alcohol, dipropyleneglycol monomethylether, methyl 5-(dimethylamino)-2-methyl-5-oxopentanoate, and/or mixtures thereof were found particularly good solvents (i), as they are high boiling, polar aprotic, low viscosity liquids, and offer a particularly good solvency for the active ingredients according to the invention, while being miscible with water at the required temperature range. These solvents also offer chemical and thermal stability, and low toxicity. Particularly preferred solvents include N-methyl pyrrolidone and γ-caprolactone.

The solvent system further comprises an essentially water immiscible solvent component (ii). In preferred embodiments the solvent component (ii) comprises one or more of aromatic hydrocarbons such as SOLVESSO solvents, paraffinic hydrocarbons such as EXXSOL solvent, cyclic hydrocarbons such as cyclohexanone and isophorone, methyl ester solvents such as methyl oleate, methyl palmitate, and methyl laurate (fatty acid based methyl esters) and canola oil or soy oil methyl esters (methylated seed and vegetable oils) and propylene glycol methyl ether, dibasic ester (usually methyl esters) of long chain di-acids ranging from C₈-C₁₆ carbon units; amides such long chain primary amides, and disubstituted amides such as C₈-C₁₂ dimethyl amides, for example N,N-Dimethyl decanamide, N,N-dimethyl lactamide, N,N-Dimethyl 9-Decenamide and N,N-dimethyl octanamide, glycerol esters such as capric/caprylic triglyceride esters, ethoxylated phosphate esters such as nonylphenol POE- 10 phosphate ester, acetates such as 2-ethylhexyl acetate, isopropyl acetate, and, isobornyl acetate, alcohols such as 2-ethylhexanol, octanol, and benzyl alcohol, Lactates such as 2-ethylhexyl lactate and butyl lactate, carbonate esters such as propylene carbonate, diphenyl carbonate, and polypropylene carbonate), citrates such as acetyl tributyl citrate, triethyl citrate, and n-butylryl tri-n-hexyl citrate, as well as other solvents such as dimethyl sulfoxide, dimethylformamide, and dimethyl isosorbides can also be utilized if desired for any reason.

Of these solvents or solvent blends (ii) comprising one or more of aromatic hydrocarbons, or higher acetates such as isobornyl acetate are particularly suited due to their high boiling points and high flash points. Preferably, solvent component (i) is selected from: monomethyl ether of propylene glycol, N-Butylpyrrolidone, γ-Caprolactone, N-methylpyrrolidone, ethyl lactate, tetrahydrofurfuryl alcohol, dipropyleneglycol monomethylether, Methyl 5-(dimethylamino)-2-methyl-5-oxopentanoate, and/or mixtures thereof.

Preferably, solvent component (ii) is selected from aromatic hydrocarbons, paraffinic hydrocarbons, cyclic hydrocarbons, fatty acid, seed and vegetable oil methyl esters, propylene glycol methyl ether, dibasic esters of long chain di-acids ranging from C8-C16 carbon atoms; long chain primary amides, and disubstituted amides such as C₈-C₁₂ dimethyl amides, glycerol esters, ethoxylated phosphate esters, acetates, long chain aliphatic or aromatic alcohols, lactates, carbonate esters, citrates dimethyl sulfoxide, dimethylformamide, and dimethyl isosorbides.

The ratio of the solvent components (i) and (ii) may be any suitable ratio that allows to maintain the active ingredient in solution, also when including the emulsifier components.

Preferably, the weight ratio of solvent (i) to Solvent (ii) is from 10:1 to 1:10.

### “Emulsifier System” (c):

Emulsifiers herein are employed in an amount of generally of from 0 to 25 wt %, preferably 0.01-15 wt % by weight of one or more emulsifiers. The emulsifier may be any suitable compound of mixture of compounds. Ionic and non-ionic emulsifiers may be used.

Suitable Ionic and/or anionic emulsifiers are phosphate esters and sulfate esters such as poly ethoxylated phosphate esters, ethoxylated tridecyl alcohol phosphate esters, ethoxylated fatty alcohol phosphate esters, and sulfate esters of polyethoxylated arylphenols.

Inorganic salts of alkylbenzenesulfonate is another group of examples for anionic emulsifiers such as sodium dodecylbenzene and triethanolamine dodecylbenzene sulfonate.

Examples of nonionic emulsifiers can also be generally from the class of polyethoxylated chemicals, such as ethoxylated alkylphenols, ethoxylated ethanolamides, amine ethoxylates, polyethoxylated castor oils, alcohol ethoxylates, ethoxylated fatty alcohols, ethoxylated castor oil, tridecyl alcohol polyglycol ethers, and ethoxylated tristyrylphenols. Ethoxylated chemicals could be replaced by or be in combination with propoxylated versions.

Other examples of emulsifiers include block copolymers, EO/PO block copolymer, butyl block copolymer, random copolymers and star polymeric surfactant are also desirable in some embodiments. Polysorbates are another example of emulsifiers, such as polyoxyethylene sorbitan monolaurate, polyoxyethylene sorbitan monooleate, sorbitan monopalmitate and sorbitan monostearate are also optionally included. Optional Antifoam agent(s) may be any suitable compound or mixture of compounds.

### Additives

Useful additive may include rheological additives, stabilizers and many other components.

Rheologically active additives include thickeners. Preferred thickeners include gums, e.g. xanthan, guar, locust bean, alginates, polyvinyl alcohol, polyacrylates, starches, clay derivatives, e.g., amine treated magnesium aluminium silicate, and cellulose derivatives, e.g., hydroxypropyl ethylcellulose. The thickeners that are most preferred are the clay derivatives, cellulose derivatives, and xanthan gum.

The purpose of a surfactant is to promote creation of a stable, homogeneous emulsion. Surfactants that are useful in the composition of the present invention include non-ionic, cationic, and anionic surfactants. The surfactants suitable for the composition of this invention preferably have an HLB value of from about 5 to about 15. If a blend of surfactants is used, it is preferred that the blend have an overall HLB value of from about 5 to about 15. The particular HLB value required is dependent upon the organic solvent selected.

Surfactants that can be used to prepare the composition of the present invention include polyoxyethylated fatty amines, polyoxyethylated ethers, polyoxyethylated sorbitan esters, polyoxyethylated sorbitol esters, dodecyl benzene sulfonic acid salts, polyalkylene oxide-modified methylpolysiloxanes, alkylphenol ethyoxylates, polyoxyethylene sorbitan fatty acid esters, and sorbitan fatty acid esters.

Surfactants that are preferred for the composition of the present invention include polyoxyethylene sorbitan monooleate and sorbitan monooleate.

Selection of the particular surfactant can be facilitated by the procedures described in Kirk-Othmer Encyclopedia of Chemical Technology, Third Edition, Vol. 8, John Wiley & Sons, Inc. (1979), 16 pp. 909-919, incorporated herein by reference, or by the procedures described in the “HLB System, a time-saving guide to emulsifier selection”, ICI United States Inc., Specialty Chemicals Division (1976).

Other additives that are useful in the composition of the present invention include abrasive particles such as aluminium oxide, silicon carbide, and pumice. The amount of organic solvent must be sufficient to insure effective removal of coatings from surfaces. The amount of thickener and the amount of surfactant must be sufficient to allow the composition to exist as a stable emulsion. The amount of water can vary and is essentially the difference between the total amount of the composition and the amount of organic solvent component, thickener component, and surfactant component.

The concentration of water in the composition can range from about 0.01% by weight to about 2% by weight and the concentration of organic solvent or solvents can range from about 10% by weight to about 90% by weight. The concentration of thickener or thickeners can range from about 1% by weight to about 10% by weight. The concentration of surfactant or surfactants can range from about 0.1% by weight to about 10% by weight. As stated previously, the composition must contain at least 50% by weight of water. At these concentrations, the concentration of solvent in the vapours of the composition is sufficiently low that ignition of the vapours will not occur upon being subjected to the flame of a match, lighter, or electrical spark, for instance.

When the EC is emulsified, the purpose of the water is to act as a carrier and to suppress the evaporation of the organic solvent, in order to allow the compositions to be applied to the surface of plants, propagation materials thereof, or the loci of the plants. Preferably, the amount of water in such emulsions or dispersions should be selected as to be sufficient to render the composition resistant to ignition when being mixed and/or applied. As used herein, the term “resistant to ignition” means incapable of being ignited upon being subjected to the flame of a lighted match or lighter or the like.

Once emulsified, the composition preferably contains at least 80% by weight water, more preferably at least 85% by weight water, and most preferably at least 90% by weight water.

The purpose of an added thickener is to stabilize the solvent/water emulsion and provide good flow control, i.e., the presence of thickener allows the composition to be applied easily, level out, and have the ability to cling to a vertical surface for a sufficient period of time for the solvent to soften the coating on the surface. It is recommended that the thickener be soluble in water or swellable in water and be capable of promoting formation of a stable emulsion of the composition of this invention.

Compositions according to the invention may include combinations not just of cyclobutrifluram and/or compounds of Table 1, but combinations of cyclobutrifluram and/or one or more compounds of Table 1 with one or more other agrochemicals may be employed.

Once emulsified in water, the compositions, at certain application rates, may have a strengthening effect in plants. Accordingly, they are also suitable for mobilizing the defence system of the plant against attack by unwanted pests and microorganisms such as bacteria and fungi. Plant-strengthening (resistance-inducing) substances are to be understood as meaning, in the present context, those substances or combinations of substances which are capable of stimulating the defence system of plants in such a way that, when subsequently inoculated with unwanted microorganisms, the treated plants display a substantial degree of resistance to these microorganisms. In the present case, unwanted microorganisms are to be understood as meaning phytopathogenic fungi, bacteria and viruses.

Compounds and compositions described herein are advantageously applied to a pest, a locus of pest, preferably a plant, or to a plant susceptible to attack by a pest. As for acari, for example, these may be Tetranychus cinnabarinus, Tetranychus urticae, Panonychus citri, Aculops pelekassi, Tarsonemus spp.

As for nematodes, for example, these are Meloidogyne incognita, Bursaphelenchus lignicolus Mamiya et Kiyohara, Aphelenchoides besseyi, Heterodera glycines, Pratylenchus spp.

Cyclobutrifluram and/or compounds of Table 1 and compositions thereof may be used against normally sensitive and resistant species and against all or some stages of development. These pests include inter alia: Anoplura (Phthiraptera), for example, Damalinia spp., Haematopinus spp., Linognathus spp., Pediculus spp., Trichodectes spp.

The compositions of the invention are also suitable for the protection of plant propagation material, for example seeds, such as fruit, tubers or kernels, or nursery plants, against pests of the abovementioned type. The propagation material can be treated with the compound prior to planting, for example seed can be treated prior to sowing. Alternatively, the compound can be applied to seed kernels (coating), either by soaking the kernels in a liquid composition or by applying a layer of a solid composition. It is also possible to apply the compositions when the propagation material is planted to the site of application, for example into the seed furrow during drilling. These treatment methods for plant propagation material and the plant propagation material thus treated are further subjects of the invention.

The method according to the invention can be used for controlling, i. e. containing or destroying, pests of the abovementioned type which occur in particular on plants, especially on useful plants and ornamentals in agriculture, in horticulture and in forests, or on organs, such as fruits, flowers, foliage, stalks, tubers or roots, of such plants, and in some cases even plant organs which are formed at a later point in time remain protected against these pests. Suitable target crops are, in particular, cereals, such as wheat, barley, rye, oats, rice, maize or sorghum; beet, such as sugar or fodder beet; fruit, for example pomaceous fruit, stone fruit or soft fruit, such as apples, pears, plums, peaches, almonds, cherries or berries, for example strawberries, raspberries or blackberries; leguminous crops, such as beans, lentils, peas or soya; oil crops, such as oilseed rape, mustard, poppies, olives, sunflowers, coconut, castor, cocoa or ground nuts; cucurbits, such as pumpkins, cucumbers or melons; fibre plants, such as cotton, flax, hemp or jute; citrus fruit, such as oranges, lemons, grapefruit or tangerines; vegetables, such as spinach, lettuce, asparagus, cabbages, carrots, onions, tomatoes, potatoes or bell peppers; Lauraceae, such as avocado, Cinnamonium or camphor; and also tobacco, nuts, coffee, eggplants, sugarcane, tea, pepper, grapevines, hops, the plantain family and latex plants. The methods of the present invention may be also used on any ornamental and/or vegetable crops, including flowers, shrubs, broad-leaved trees and evergreens

The following, non-limiting examples illustrate compositions according to the invention:

### EXAMPLES

### Example 1

| | Amount | |
|---|---|---|
| | [%] | |
| | weight/ | |
| Name (Trade Name) | weight | Role |
| N-[(1S,2S)-2-(2,4-dichlorophenyl)cyclobutyl]-2- | 10 | Active |
| (trifluoromethyl)pyridine-3-carboxamide | | ingredient |
| (cyclobutrifluram) | | |
| Dipropyleneglycol monomethylether (mixture of | 57 | Solvent |
| isomers) | | |
| Isobornyl acetate | 23 | Solvent |
| Complex organic phosphate ester, free acid | 2 | Surfactant |
| Ethoxylated tristyrylphenol | 8 | Surfactant |
| Total | 100 | |

### Example 2

| | Amount | |
|---|---|---|
| | [%] | |
| Name (Trade Name) | w/w | Role |
| N-[(1S,2S)-2-(2,4-dichlorophenyl)cyclobutyl]-2- | 10 | Active |
| (trifluoromethyl)pyridine-3-carboxamide | | ingredient |
| (cyclobutrifluram) | | |
| N-Butylpyrrolidone | 57.17 | Solvent |
| Isobornyl acetate | 20.8 | Solvent |
| Complex organic phosphate ester, free acid | 4 | Surfactant |
| Condensation product of castor oil and ethylene- | 4 | Surfactant |
| oxide (AGNIQUE CSO-36) | | |
| Propylene-oxide/ethylene-oxide copolymer | 4 | Surfactant |
| Silicone antifoam emulsion | 0.03 | Antifoam |
| Total | 100 | |

### Example 3

| | Amount | |
|---|---|---|
| | [%] | |
| Name (Trade Name) | w/w | Role |
| N-[(1S,2S)-2-(2,4-dichlorophenyl)cyclobutyl]-2- | 10 | Active |
| (trifluoromethyl)pyridine-3-carboxamide | | ingredient |
| (cyclobutrifluram) | | |
| Dimethylamide ether type solvent (RHODIASOLV | 14 | Solvent |
| POLARCLEAN) | | |
| Isobornyl acetate | 68 | Solvent |
| Dodecyl-benzene sulfonic acid Calcium salt, linear | 6 | Surfactant |
| Condensation product of castor oil and ethylene- | 2 | Surfactant |
| oxide (AGNIQUE CSO-36) | | |
| Total | 100 | |

The compositions of examples 1 to 3 were subsequently subjected to storage stability test at low and high temperature. This included 2 weeks at −10° C., and 2 weeks at 54° C. All exemplified compositions remained clear liquids.

The compositions of examples 1 to 3 were also subjected to dilution tests, whereby oil-in-water emulsions were prepared by adding 3% v/v in both 50 and 500 ppm water; and stability as observed for at least 24 hours. All exemplified compositions remained stable emulsions.

1. A stable, single-phase emulsifiable composition, comprising:
(a) one or more compounds selected from: N-[(1,2 cis)-2-(2,4-dichlorophenyl)cyclobutyl]-2-(trifluoromethyl)pyridine-3-carboxamide (1, cyclobutrifluram), and the following close analogues thereof: N-[(1,2 cis)-2-(2,4-difluorophenyl)cyclobutyl]-2-(trifluoromethyl)benzamide (2); N-[(1,2 cis)-2-(2,4-difluorophenyl)cyclobutyl]-2-(trifluoromethyl)pyridine-3-carboxamide (3); N-[(1,2 cis)-2-(2,4-difluorophenyl)cyclobutyl]-3-(trifluoromethyl)pyrazine-2-carboxamide (4); N-[(1,2 cis)-2-[2-chloro-4-(trifluoromethyl)phenyl]cyclobutyl]-3-(trifluoromethyl)pyridine-2-carboxamide (5); N-[(1,2 cis)-2-[2-chloro-4-(trifluoromethyl)phenyl]cyclobutyl]-2-(trifluoromethyl)pyridine-3-carboxamide (6); N-[(1,2 cis)-2-[2-chloro-4-(trifluoromethyl)phenyl]cyclobutyl]-3-(trifluoromethyl)pyrazine-2-carboxamide (7); N-[(1,2 cis)-2-[2-fluoro-4-(trifluoromethyl)phenyl]cyclobutyl]-2-(trifluoromethyl)benzamide (8); N-[(1,2 cis)-2-[2-fluoro-4-(trifluoromethyl)phenyl]cyclobutyl]-3-(trifluoromethyl)pyridine-2-carboxamide (9); N-[(1,2 cis)-2-[2-fluoro-4-(trifluoromethyl)phenyl]cyclobutyl]-2-(trifluoromethyl)pyridine-3-carboxamide (10); N-[(1,2 cis)-2-[2-fluoro-4-(trifluoromethyl)phenyl]cyclobutyl]-3-(trifluoromethyl)pyrazine-2-carboxamide (11); N-[(2,3 cis)-2-(2,4-difluorophenyl)oxetan-3-yl]-2-(trifluoromethyl)benzamide (12); N-[(2,3 cis)-2-(2,4-difluorophenyl)oxetan-3-yl]-2-(trifluoromethyl)pyridine-3-carboxamide (13); N-[(1,2 cis)-2-(2,4-dichlorophenyl)cyclobutyl]-3-(trifluoromethyl)pyridine-2-carboxamide (14); N-[(1,2 cis)-2-(2-chloro-4-fluoro-phenyl)cyclobutyl]-2-(trifluoromethyl)pyridine-3-carboxamide (15); N-[(1,2 cis)-2-(2-chloro-4-fluoro-phenyl)cyclobutyl]-3-(trifluoromethyl)pyridine-2-carboxamide (16); N-[(1,2 cis)-2-(2,4-difluorophenyl)cyclobutyl]-3-(trifluoromethyl)pyridine-2-carboxamide (17); N-[(1,2 cis)-2-(4-chloro-2-fluoro-phenyl)cyclobutyl]-3-(trifluoromethyl)pyridine-2-carboxamide (18); N-[(1,2 cis)-2-(2-chloro-4-fluoro-phenyl)cyclobutyl]-2-(trifluoromethyl)benzamide (19); N-[(1,2 cis)-2-[4-fluoro-2-(trifluoromethyl)phenyl]cyclobutyl]-2-(trifluoromethyl)pyridine-3-carboxamide (20); N-[(1,2 cis)-2-(4-chloro-2-fluoro-phenyl)cyclobutyl]-2-(trifluoromethyl)-pyridine-3-carboxamide (21); N-[(1,2 cis)-2-(2-chloro-4-fluoro-phenyl)cyclobutyl]-4-(trifluoromethyl)thiazole-5-carboxamide (22); N-[(1,2 cis)-2-(4-chloro-2-fluoro-phenyl)cyclobutyl]-3-(trifluoromethyl)pyrazine-2-carboxamide (23); N-[(1,2 cis)-2-(4-chloro-2-fluoro-phenyl)cyclobutyl]-2-(trifluoromethyl)benzamide (24); and N-[(1,2 cis)-2-(2,4-difluorophenyl)cyclobutyl]-4-(trifluoromethyl)thiazole-5-carboxamide (25); N-[(1,2 cis)-2-(2,4-dichlorophenyl)cyclobutyl]-2-(trifluoromethyl)pyridine-3-carboxamide (26); N-[(1,2 cis)-2-(2,4-difluorophenyl)cyclobutyl]-2-(trifluoromethyl)benzamide (27); N-[(1,2 cis)-2-(2,4-difluorophenyl)cyclobutyl]-2-(trifluoromethyl)pyridine-3-carboxamide (28); N-[(1,2 cis)-2-(2,4-difluorophenyl)cyclobutyl]-3-(trifluoromethyl)pyrazine-2-carboxamide (29); N-[(2,3 cis)-2-(2,4-difluorophenyl)oxetan-3-yl]-2-(trifluoromethyl)benzamide (30); N-[(2,3 cis)-2-(2,4-difluorophenyl)oxetan-3-yl]-2-(trifluoromethyl)pyridine-3-carboxamide (31); N-[(1,2 cis)-2-(2-chloro-4-fluoro-phenyl)cyclobutyl]-2-(trifluoromethyl)pyridine-3-carboxamide (32); N-[(1,2 cis)-2-(2-chloro-4-fluoro-phenyl)cyclobutyl]-3-(trifluoromethyl)pyridine-2-carboxamide (33); N-[(1,2 cis)-2-(2,4-difluorophenyl)cyclobutyl]-3-(trifluoromethyl)pyridine-2-carboxamide (34); N-[(1,2 cis)-2-(4-chloro-2-fluoro-phenyl)cyclobutyl]-3-(trifluoromethyl)pyridine-2-carboxamide (35); and N-[(1,2 cis)-2-(4-chloro-2-fluoro-phenyl)cyclobutyl]-2-(trifluoromethyl)pyridine-3-carboxamide (36), stereoisomers, tautomers, salts or N-oxides thereof; and
(b) a solvent system comprising:
(i) at least one non-aqueous polar solvent classified by a Hp (Hansen Polarity) value in the range of from 5 to 15 and a Hh (Hansen H-Bonding) parameter in a range of from 5 to 15, and
(ii) at least one water immiscible apolar solvent; and
(c) an emulsifying surfactant system enabling an oil in water emulsion to be formed when the emulsifiable concentrate is added to water, thereby forming an Emulsifiable concentrate (EC).

2. The composition according to claim 1, wherein the one or more compounds (a) are present in an amount of from 0.01 to 15% by weight.

3. The composition according to claim 1, comprising an amount of water at or below 2% by weight of the composition.

4. The composition according to a claim 1, wherein compound (a) comprises one or more stereoisomers of N-[(1,2 cis)-2-(2,4-dichlorophenyl)cyclobutyl]-2-(trifluoromethyl)pyridine-3-carboxamide.

5. The composition according to claim 1, wherein the solvent component (i) is selected from: monomethyl ether of propylene glycol, N-Butylpyrrolidone, γ-Caprolactone, N-methylpyrrolidone, ethyl lactate, tetrahydrofurfuryl alcohol, dipropyleneglycol monomethylether, Methyl 5-(dimethylamino)-2-methyl-5-oxopentanoate, and/or mixtures thereof.

6. The composition according to claim 1, wherein the solvent component (ii) is selected from aromatic hydrocarbons, paraffinic hydrocarbons s, cyclic hydrocarbons, fatty acid, seed and vegetable oil methyl esters, propylene glycol methyl ether, dibasic esters of long chain di-acids ranging from C₈-C₁₆ carbon atoms; long chain primary amides, and disubstituted amides such as C₈-C₁₂ dimethyl amides, glycerol esters, ethoxylated phosphate esters, acetates, long chain aliphatic or aromatic alcohols, lactates, carbonate esters, citrates dimethyl sulfoxide, dimethylformamide, and dimethyl isosorbides.

7. The composition according to claim 1, wherein the weight ratio of solvent (i) to Solvent (ii) is from 10:1 to 1:10.

8. A process for the preparation of the composition according to claim 1, comprising contacting an aliquot of one or more of compounds 1 to 36 with at least one of the solvents (i) and/or (ii), and optionally, at least a portion of the emulsifying surfactant system, to form the composition as a preformed concentrate composition capable of forming emulsion/micro-emulsion upon dilution with water,

9. A process for the preparation of an aqueous emulsion or dispersion, comprising contacting a composition according to claim 1 with an aqueous liquid carrier under conditions inducive of the formation of an emulsion or dispersion.

10. An emulsion-in-water formulation obtainable according to claim 9, comprising a composition thereof diluted in water to form a concentrated aqueous agrochemical formulation.

11. A method for preventing or controlling pathogens in crops of useful plants, comprising treating the plants, plant parts, plant propagation materials or locus thereof with an agrochemically effective amount of a water-diluted spray composition or oil-in-water emulsion formed when the composition according to claim 1 is added to an aqueous liquid carrier.

12. Use of the composition according to claim 1, for the storage and transport of the one or more compounds 1 to 36.

13. Use of the composition according to claim 1, for the preparation of an oil-in-water emulsion.

14. Use of the composition according to claim 1, for the control of undesired plant pathogens, in particular nematodes and/or fungi.
